(19) United States
(12) Patent Application Publication
(10) Pub. No.: US 2025/0284439 A1
(43) Pub. Date: Sep. 11, 2025

(54) PRINT CONTROL PROGRAM, IMAGE PROCESSING SYSTEM, AND IMAGE PROCESSING METHOD

(71) Applicant: SEIKO EPSON CORPORATION, Tokyo (JP)

(72) Inventor: Atsushi YUMOTO, Shiojiri (JP)

(21) Appl. No.: 19/071,822

(22) Filed: Mar. 6, 2025

(30) Foreign Application Priority Data
Mar. 8, 2024 (JP) 2024-035601

(51) Int. Cl. G06F 3/12

(52) U.S. Cl. CPC G06F 3/1228; G06F 3/1205; G06F 3/1261

(57) ABSTRACT

A print control program according to one aspect of the present disclosure causes a computer to execute acquisition processing, display processing, and image processing. In the acquisition processing, device information of the printer having a scanning function is acquired from the general-purpose printer driver 16. In the display processing, one user interface image is selected from a plurality of user interface images based on the device information and is displayed. In the image processing, the printer performs scanning for printing based on an instruction from a user via the one user interface image described above.

The present application is based on, and claims priority from JP Application Serial Number 2024-035601, filed Mar. 8, 2024, the disclosure of which is hereby incorporated by reference herein in its entirety.

### BACKGROUND

### 1. Technical Field

The present disclosure relates to a print control program, an image processing system, and an image processing method.

### 2. Related Art

JP-A-2005-341216 discloses a copy print device that allows settings related to copy print to be more easily performed regardless of a type of a document to be scanned.

However, in the technique disclosed in JP-A-2005-341216, a dedicated printer driver or a dedicated scan driver is required. Meanwhile, when image processing such as printing or scanning is executed using a general-purpose printer driver such as an operating system (OS) standard printer driver, the following processing is performed. That is, in this case, the general-purpose printer driver displays a common user interface image regardless of the printer that executes the image processing, and the same image processing settings are set by default.

Therefore, in an environment in which a general-purpose printer driver is used to cause a printer to execute image processing for printing or scanning, it is desirable to develop a technique of providing a user with a setting suitable for the printer as a default setting.

### SUMMARY

A non-transitory computer-readable storage medium stores a print control program according to one aspect of the present disclosure, and the print control program causes a computer to execute: acquisition processing of acquiring device information of a printer having a scanning function from a general-purpose printer driver; display processing of selecting one user interface image from a plurality of user interface images based on the device information and displaying the one user interface image; and image processing of causing the printer to perform scanning or printing based on an instruction from a user via the one user interface image.

An image processing system according to one aspect of the present disclosure includes: a general-purpose printer driver; an acquisition processing unit configured to acquire device information of a printer from the general-purpose printer driver; a display processing unit configured to select one user interface image from a plurality of user interface images based on the device information and display the one user interface image; and an image processing unit configured to cause the printer to perform scanning or printing based on an instruction from a user via the one user interface image.

An image processing method according to one aspect of the present disclosure includes: acquisition processing of a computer acquiring device information of a printer from a general-purpose printer driver; display processing of the computer selecting one user interface image from a plurality of user interface images based on the device information and displaying the one user interface image; and image processing of the computer causing the printer to perform scanning or printing based on an instruction from a user via the one user interface image.

### BRIEF DESCRIPTION OF THE DRAWINGS

FIG. 1 is a block diagram illustrating a configuration example of a print system according to an embodiment.

FIG. 2 is a flowchart illustrating an example of selection processing of a user interface image in the print system in FIG. 1.

FIG. 3 is a diagram illustrating a table indicating an example of a result of the selection processing in FIG. 2.

FIG. 4 is a diagram illustrating an example of a user interface image displayed at the time of printer selection in the print system in FIG. 1.

FIG. 5 is a diagram illustrating an example of the user interface image selected in the selection processing in FIG. 2.

FIG. 6 is a diagram illustrating another example of the user interface image selected in the selection processing in FIG. 2.

FIG. 7 is a sequence diagram illustrating an example of image processing in the print system in FIG. 1.

FIG. 8 is a diagram illustrating an example of a hardware configuration of a device.

### DESCRIPTION OF EMBODIMENTS

Hereinafter, an embodiment according to the present disclosure will be described with reference to the drawings. The drawings are merely an example illustrating the embodiment of the present disclosure. Not all components described in the embodiment of the present disclosure are essential components of the present disclosure.

### Embodiment

### Configuration of System

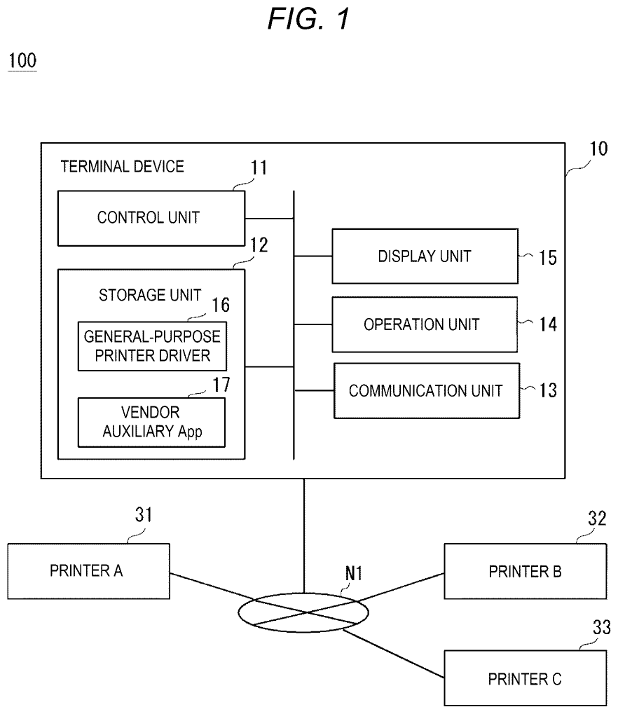

An image processing system according to the embodiment is a system capable of printing and scanning documents, and therefore can be called a print system or a scan system. Hereinafter, a configuration example of the print system according to the embodiment is described with reference to FIG. 1. FIG. 1 is a block diagram illustrating the configuration example of the print system according to the embodiment.

As illustrated in FIG. 1, a print system 100 according to the embodiment can include a terminal device 10, a printer A (31), a printer B (32), and a printer C (33).

The terminal device 10 is an information processing device having a communication function such as a personal computer (PC), a smartphone, or a tablet terminal and can be used by a user who desires to print or scan documents. The terminal device 10 is connected to the printer A (31), the printer B (32), and the printer C (33) via a network N1 for processing of transmitting a print request or a document scan request. Although not illustrated, the print system 100 can include a plurality of the terminal devices 10.

All of the printer A (31), the printer B (32), and the printer C (33) are examples of printers having a scanning function. The scanning function is a function of optically reading an image from the document and may be referred to as a document reading function. All of the printer A (31), the printer B (32), and the printer C (33) can print the print data on a medium when receiving the print data, and can also scan a document when the document is placed thereon and a scan instruction is received. Each printer produces a printed matter by performing printing and generates image data by performing scanning.

The print system 100 performs, according to a user operation from the terminal device 10, printing in a printer selected from the printer A (31), the printer B (32), and the printer C (33). The print system 100 can scan a document placed on a document table or an automatic document feeder in a printer selected from the printer A (31), the printer B (32), and the printer C (33) by the user operation from the terminal device 10.

For the sake of convenience, the print system 100 is described assuming a configuration including three printers as described above, but it is sufficient that the print system 100 includes at least one printer. Each of the printers can also be referred to as a print device, an image formation device, or a multifunction device. Each of the printers may be a device having a scanning function, a communication function, and a print function, and may be a multifunction device having other functions such as a copy function and a facsimile function. The copy function is implemented by the scanning function and the print function. A printing method in each of the printers does not matter, and various printing methods such as an inkjet printing method or a laser printing method can be applied.

Hereinafter, a configuration example of the terminal device 10 is described in detail. Description of a configuration example of each of the printers is omitted.

### Configuration of Terminal Device 10

As illustrated in FIG. 1, the terminal device 10 can include a control unit 11, a storage unit 12, a communication unit 13, an operation unit 14, and a display unit 15.

The control unit 11 controls the entire terminal device 10. The control unit 11 can include, for example, an arithmetic processing device, a working memory, and a storage device that stores a control program, parameters, and the like. The arithmetic processing device described above can be a central processing unit (CPU), a graphics processing unit (GPU), or the like. The control unit 11 can also be implemented as a system on a chip (SoC). As can be seen from these examples, the control unit 11 can be configured to store the control program in an executable state. The control unit 11 may have a configuration in which a part of the control program is stored as a circuit configuration such as a field-programmable gate array (FPGA), or may be implemented as a dedicated circuit.

The control program described above can include a program for the arithmetic processing device to execute processing related to the printing in cooperation with the storage unit 12, the communication unit 13, the operation unit 14, and the display unit 15. The control program described above can include an operating system (OS). Since the OS is an OS mounted on the terminal device 10, a type of the OS depends on a model of the terminal device 10 or the like. The control program described above can include a Web browser in the OS or outside the OS. In the following, an example is described in which at least a part of the control program is stored in the storage unit 12 provided separately from the control unit 11, and the storage unit 12 may be a part of the storage device in the control unit 11. That is, the storage unit 12 can be grasped as a part of the control unit 11.

The storage unit 12 is, for example, a storage device implemented by a hard disk drive, a solid state drive, or another memory. The storage unit 12 stores, as a part of the control program, a general-purpose printer driver 16 and a vendor auxiliary application program 17 to be described later in a state executable by the control unit 11. Hereinafter, the vendor auxiliary application program is abbreviated as a vendor auxiliary App. The storage unit 12 can store various types of data such as data of a file to be printed and the image data obtained by scanning.

The communication unit 13 is a part for communicating wirelessly or wired with external devices such as the printer A (31), the printer B (32), and the printer C (33) via the network N1 according to various mobile communication standards or predetermined communication standards such as the Wi-Fi (registered trademark, the same applies below) standard. The communication unit 13 can be implemented by one or a plurality of communication interfaces enabling such communications. The communication interface may be, for example, an antenna or a cable connector. The network N1 is usually a local area network (LAN).

The operation unit 14 is a part for receiving operations by the user of the terminal device 10 and can also be referred to as an operation reception unit. The operation unit 14 can be implemented by, for example, any one or a plurality of a physical button, a touch panel mounted on the display unit 15, a pointing device, and a keyboard. In a configuration in which the operation unit 14 includes a touch panel, the display unit 15 and the touch panel can be collectively referred to as an operation panel of the terminal device 10.

The display unit 15 is a part for displaying a user interface (UI) image for operating the terminal device 10 and is implemented by a display device such as a liquid crystal display or an organic electroluminescence display. The display unit 15 can include a display and a drive circuit that drives the display.

The general-purpose printer driver 16 is described. The general-purpose printer driver 16 is an OS-standard printer driver provided in an OS included in the control program or attached to the OS. For various types of printers, the general-purpose printer driver 16 can be a program capable of controlling the printers to perform printing. The general-purpose printer driver 16 can also be referred to as an OS general-purpose printing program or a general-purpose printing program.

The general-purpose printer driver 16 is a driver that uses a general-purpose protocol for a search for a printer and for printing. For example, the general-purpose printer driver 16 uses mDNS/DNS-SD for the search for the printer and uses IPP for the printing in the printer. Here, DNS is an abbreviation for domain name system. mDNS is an abbreviation for multicast DNS. DNS-SD is an abbreviation for DNS service discovery. IPP is an abbreviation for internet printing protocol.

As can be seen from these examples, the general-purpose printer driver 16 can be, for example, an IPP class driver. IPP is an example of a standard protocol for controlling management and printing of the printer. The IPP acquires and controls printer information according to hypertext transfer protocol (HTTP) POST requests and responses. In the IPP, the printer can be set and a state of the printer can be acquired. Here, secure communication can be performed by using HTTP secure (HTTPS) instead of HTTP.

The vendor auxiliary App 17 is described. The vendor auxiliary 17 is an application program for assisting the general-purpose printer driver 16 and is used to expand functions of the general-purpose printer driver 16. Therefore, the general-purpose printer driver 16 can have a function of starting the vendor auxiliary App 17 and transmitting a print job to the vendor auxiliary App 17. The vendor auxiliary App 17 may be, for example, a print support application (PSA). One print job refers to instructions for a series of operations for printing one or a plurality of printed matters and includes the print data and print settings. When printing a plurality of printed matters, one print job can refer to instructions of a series of operations for printing printed matters having the same printing content.

The vendor auxiliary App 17 can be a program for assisting the general-purpose printer driver 16 and causing a computer to execute print control suitable for performances of a target printer, that is, print control for supporting a unique function of the printer. Here, the computer refers to the terminal device 10 or the control unit 11. When acquiring the print job from the general-purpose printer driver 16, the vendor auxiliary App 17 can convert the print job such that printing using a unique function of a specified printer can be executed by the printer.

In the embodiment, a scanning function is included as a unique function of the printer. That is, as an extension function, the vendor auxiliary App 17 has a scanning function of controlling the printer to scan the document and store the image data for various types of printers. Hereinafter, a job for scanning is described as a scan job and is distinguished from a print job. One scan job refers to an instruction for a series of operations for scanning one or a plurality of documents and includes a scan setting. When scanning a plurality of documents, one scan job refers to an instruction for a series of operations for scanning a plurality of documents to create one file or a file for each document according to the scan setting. When the vendor auxiliary App 17 is activated by the general-purpose printer driver 16 and receives the scan instruction designating a printer from the user, the printer can perform scanning using a unique function of the designated printer.

The vendor auxiliary App 17 is an application program provided by, for example, a vendor of the printer. The vendor auxiliary App 17 can be provided to the user of the terminal device 10 by being disclosed in, for example, an application store of an OS provider. Alternatively, the vendor auxiliary App 17 can be provided to the user by being included in the OS or attached to the OS.

The vendor auxiliary App 17 includes a print control program to be described later. That is, the print control program can also be implemented as, for example, a PSA. The print control program is a program for causing a computer to execute acquisition processing, display processing, and image processing to be described later. Here, the computer also refers to the terminal device 10 or the control unit 11.

In the acquisition processing, device information of the printer is acquired from the general-purpose printer driver 16. As described above, the printer has a scanning function. This acquisition is executed by inter-process communication between the general-purpose printer driver 16 and the vendor auxiliary App 17. The general-purpose printer driver 16 can acquire the device information from the printer and transmit the device information to the vendor auxiliary App 17. That is, the vendor auxiliary App 17 can acquire the device information of the printer via the general-purpose printer driver 16.

A printer serving as a subject to acquire the device information may be, for example, a default printer, or a printer selected by the user as a printer that performs printing or scanning in the general-purpose printer driver 16 or the vendor auxiliary App 17. A printer queue for the printer is registered in the terminal device 10.

Alternatively, a printer serving as an acquisition subject of the device information may be all printers connected to the network N1 or a plurality of printers with registered printer queues. In this case, one printer is selected by the user as a printer that performs printing or scanning from the printers that acquire the device information.

Hereinafter, an example is described in which a printer serving as a subject to acquire the device information and execute the image processing is the printer A (31), and the same applies to both the printer B (32) and the printer C (33).

In the display processing, one UI image is selected from a plurality of UI images and is displayed based on the device information of the printer A (31) acquired in the acquisition processing. A display destination is the display unit 15. The plurality of UI images described above can be stored in the storage unit 12 in advance. In the display processing, one UI image is selected and displayed based on the device information of the printer A (31) from the plurality of UI images stored in the storage unit 12. The plurality of UI images described above, which serves as a selection source, are UI images having different display forms and default setting values. For example, the plurality of UI images described above are three UI images including a UI image corresponding to the device information of the printer A (31), a UI image corresponding to the device information of the printer B (32), and a UI image corresponding to the device information of the printer C (33). Of course, the UI images corresponding to two of the printer A (31), the printer B (32), and the printer C (33) may be the same.

In the image processing, the printer A (31) performs scanning or printing based on an instruction from the user via the one UI image described above. Hereinafter, this instruction is referred to as an image processing instruction. The image processing instruction is an instruction indicated by an operation received from the user by the operation unit 14. The image processing instruction can include a final instruction to start scanning. However, the image processing instruction received by the operation unit 14 may not include such a final instruction, and the final instruction may be received as an instruction from an operation panel provided in a main body of the printer A (31).

This image processing instruction can be transmitted by the vendor auxiliary App 17 via the general-purpose printer driver 16 or directly, that is, without using the general-purpose printer driver 16 to the printer A (31). In either case, the control unit 11 transmits the image processing instruction to the printer A (31) via the communication unit 13. When the image processing instruction is a print instruction, the print data to be printed is also transmitted to the printer A (31).

When the image processing instruction is transmitted to the printer A (31) by the vendor auxiliary App 17 without using the general-purpose printer driver 16, the vendor auxiliary App 17 communicates with the printer A (31). The communication between the vendor auxiliary App 17 and the printer A (31) may be executed according to vendor-extended IPP protocol, or other SNMP or vendor-specific protocols. SNMP is an abbreviation for simple network management protocol.

The printer A (31) that receives the image processing instruction in this way executes the following processing. When the image processing instruction is a print instruction, the printer A (31) performs printing based on the print data and outputs the printed matter. In contrast, when the image processing instruction is a scan instruction, the printer A (31) scans the document to generate the image data, and transmits the generated image data to the terminal device 10. The terminal device 10 can receive the image data via the communication unit 13, and the vendor auxiliary App 17 can store the image data in the storage unit 12.

The print control program according to the embodiment is described above. In other words, the embodiment can provide an image processing method including the above-described acquisition processing, display processing, and image processing executed by the computer. This image processing method can be referred to as a print method when executing printing and a scan method when executing scanning.

Further, in other words, the terminal device 10 or the print system 100 includes the general-purpose printer driver 16 and the following acquisition processing unit, display processing unit, and image processing unit. The acquisition processing unit acquires the device information of the printer A (31) from the general-purpose printer driver 16. The display processing unit selects and displays one UI image from a plurality of UI images based on the device information. The display processing unit controls the display unit 15 to perform display, and therefore can also be referred to as a display control unit. The image processing unit causes the printer A (31) to perform scanning or printing based on an instruction from the user via the one UI image described above. The image processing unit may be referred to as an operation unit by operating the printer A (31) to perform scanning or printing. The terminal device 10 may be referred to as a print control device when executing printing and may be referred to as a scan control device when executing scanning. The print system 100 can also be referred to as a scan system when executing scanning.

### Examples of Scan Processing

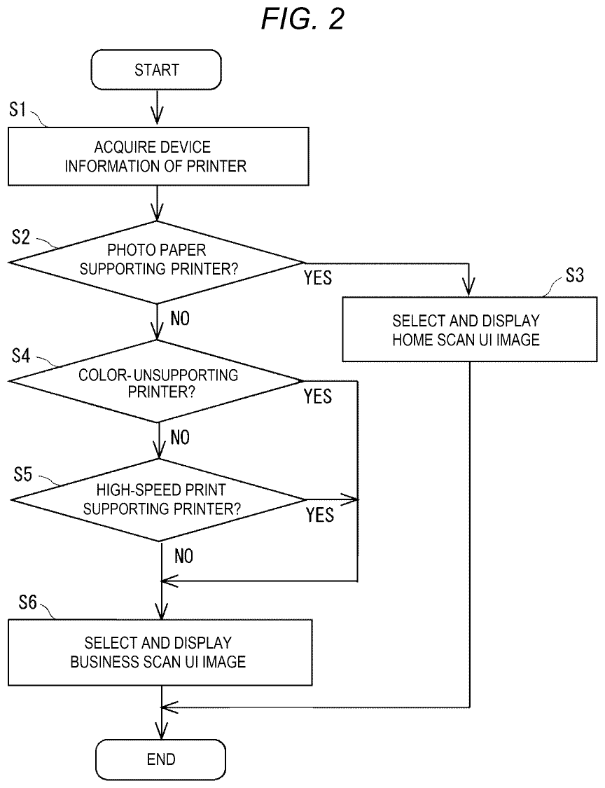

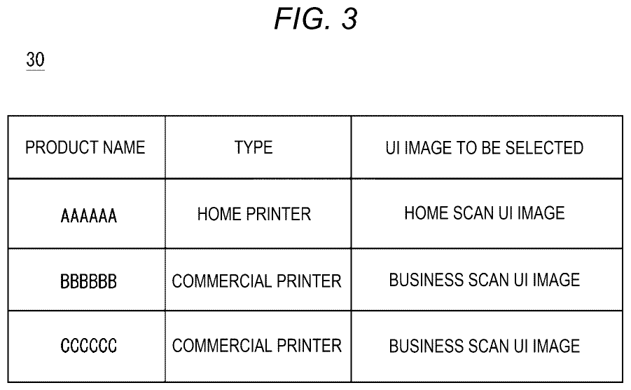

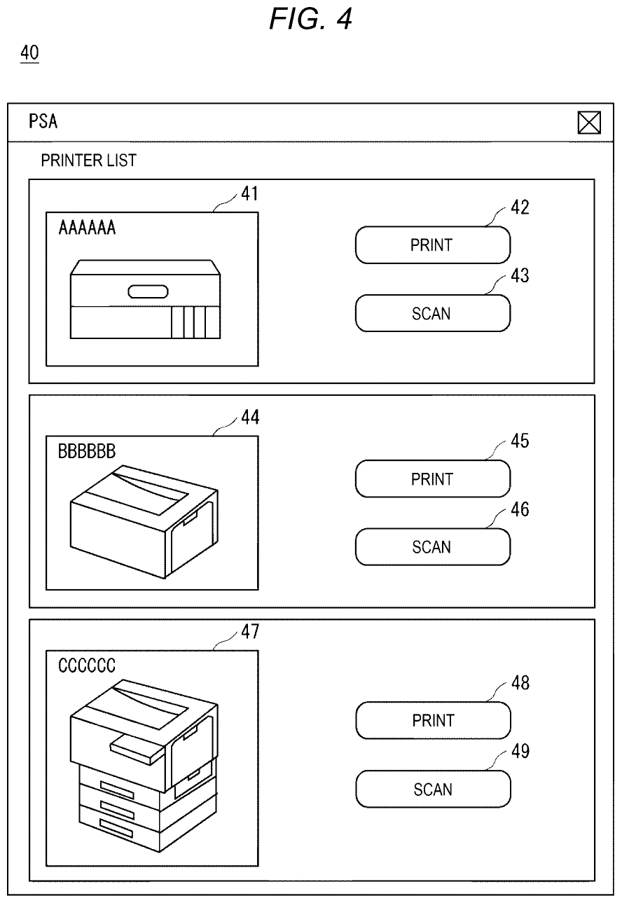

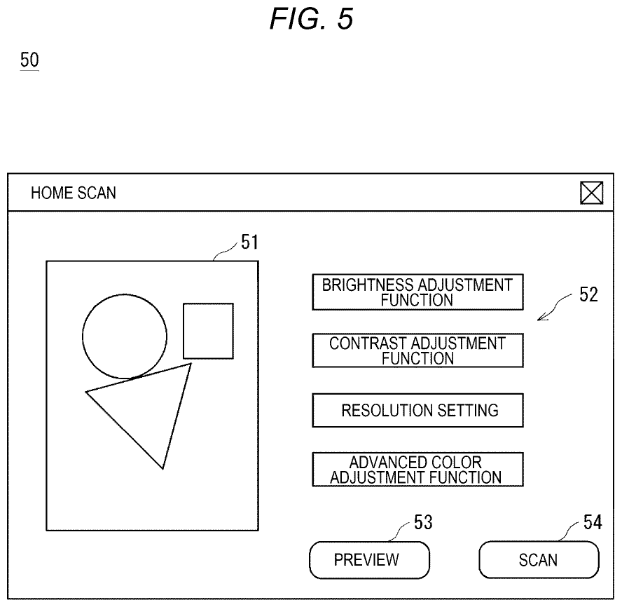

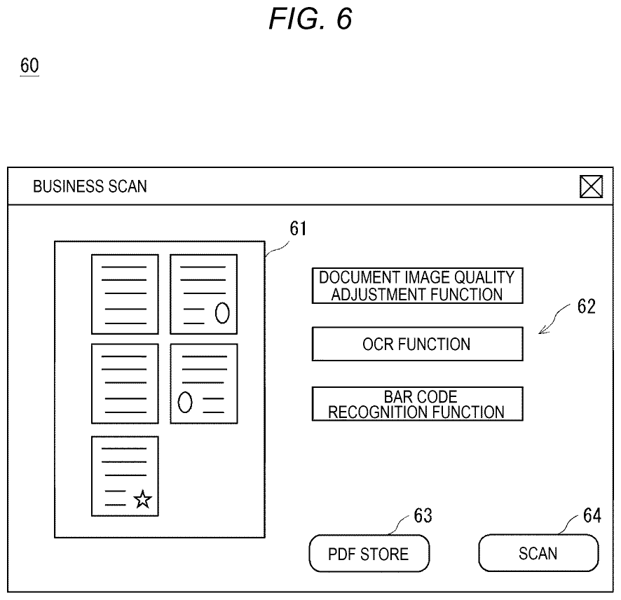

As an example of the image processing according to the embodiment, an example of scan processing will be described with reference to FIGS. 2 to 7. First, an example of selection processing of the UI image in the display processing will be described with reference to FIGS. 2 to 6. FIG. 2 is a flowchart illustrating an example of the selection processing of the UI image in the print system 100. FIG. 3 is a diagram illustrating a table indicating an example of a result of the selection processing in FIG. 2. FIG. 4 is a diagram illustrating an example of a UI image displayed at a time of printer selection in the print system 100. FIG. 5 is a diagram illustrating an example of a UI image selected in the selection processing in FIG. 2. FIG. 6 is a diagram illustrating another example of the UI image selected in the selection processing in FIG. 2.

Hereinafter, an example is described in which the vendor auxiliary App 17 is implemented with the print control program for performing the acquisition processing, the display processing, and the image processing described above. The image processing in this example is the scan processing.

Here, an example is described in which a product name of the printer A (31) is “AAAAAA”, a product name of the printer B (32) is “BBBBBB”, and a product name of the printer C (33) is “CCCCCC”. Here, the product “AAAAAA” is a machine supporting photo paper, the product “BBBBBB” is a monochrome machine that does not support the photo paper, and the product “CCCCCC” is a color machine that does not support the photo paper and is also a high-speed printer. In this case, classification indicated in a table 30 in FIG. 3 can be performed. That is, the printer A (31) can be classified into a home printer, and the printer B (32) and the printer C (33) can be classified into commercial printers, that is, business printers.

Hereinafter, an example is basically described in which the scan instruction is transmitted from the terminal device 10 to the printer A (31), and the same applies to transmitting the scan instruction to other printers such as the printer B (32) and the printer C (33).

When executing scanning, for example, the general-purpose printer driver 16 selects the printer A (31) that performs scanning by default or the user operation, and activates the vendor auxiliary App 17. Then, the vendor auxiliary App 17 acquires the device information of the selected printer A (31) from the printer A (31) via the general-purpose printer driver 16 (step S1).

The device information can be acquired by an IPP protocol as an IPP attribute. The IPP attribute is a type of attribute that can be acquired by an IPP class driver from the printer. When the vendor auxiliary App 17 is PSA, any IPP attribute can be acquired from the printer in an Ipp Print Device, which is one of the APIs provided by Microsoft (registered trademark). That is, in the acquisition processing described above, the device information can be acquired using the Ipp Print Device. API is an abbreviation for application programming interface.

A method for acquiring the device information is not limited thereto, and the device information can also be acquired, for example, as information of scan API “ImageScanner” of Windows (registered trademark, the same applies below). In this case, although an amount of information that can be acquired is less than that by Ipp Print Device, information about a resolution and a scan area can be acquired. In other words, abundant information as the device information can be acquired by using IPP as compared with a case of using the scan API described above.

In step S1, the device information of the printer A (31) can also be acquired by the following alternative procedure. That is, the vendor auxiliary App 17 acquires device information of all printers connected to the network N1 or all printers with registered printer queues from each of the printers via the general-purpose printer driver 16. When acquiring device information even from a printer with no printer queue registered, the registration may be performed before the acquisition.

When adopting the alternative procedure described above, the user selects one printer, in this example, the printer A (31) as a printer that performs scanning from the printers from which the device information is acquired. The device information of the printer A (31) selected in this way is already acquired.

A method for selecting the printer A (31) in the alternative procedure described above will be described. For example, as illustrated in a UI image 40 in FIG. 4, the vendor auxiliary App 17 can display a list of printers from which the device information is acquired on the display unit 15 and allow the user to perform selection by the operation unit 14. The UI image 40 includes, for the printer A (31), appearance information 41 indicating a photo or an illustration thereof, a print button 42, and a scan button 43. When the print button 42 is selected, the processing proceeds to the print processing in the printer A (31). In this example, when the scan button 43 is selected, the scan processing in the printer A (31) is selected as an execution target. The UI image 40 further includes appearance information 44, a print button 45, and a scan button 46 for the printer B (32), and appearance information 47, a print button 48, and a scan button 49 for the printer C (33). For example, when the scan button 49 is selected, the scan processing in the printer C (33) is selected as an execution target.

Subsequent to step S1 or the alternative procedure, the vendor auxiliary App 17 determines product specifications of the printer A (31) based on the device information, selects a scan UI image appropriate for the product specifications, and displays the selected scan UI image on the display unit 15. For example, this selection can be performed as follows.

First, the vendor auxiliary App 17 refers to a “media type” attribute of the IPP and determines whether the printer A (31) is a photo paper supporting printer based on whether photo paper is included (step S2).

If YES in step S2, the vendor auxiliary App 17 regards the printer A (31) as a home printer. Then, the vendor auxiliary App 17 selects, from the plurality of UI images stored in the storage unit 12, a home scan UI image as exemplified in a UI image 50 in FIG. 5, and displays the selected home scan UI image on the display unit 15 (step S3).

As illustrated, the UI image 50 includes, for example, a preview image 51, a button group 52 for shifting to various setting UI images, a preview button 53 for displaying the preview image 51, and a scan button 54 for executing scanning. The button group 52 can include, for example, a brightness adjustment function button for shifting to a UI image for brightness adjustment and a contrast adjustment function button for shifting to a UI image for contrast adjustment. The button group 52 can further include, for example, a resolution setting button for shifting to a UI image for setting a reading resolution and an advanced color adjustment function button for shifting to a UI image for performing advanced color adjustment. The selection processing is ended by the processing in step S3, and then the scan processing is executed by selecting the scan button 54.

If NO in step S2, the vendor auxiliary App 17 proceeds to the next determination. Specifically, the vendor auxiliary App 17 refers to a “color-supported” attribute of the IPP and determines whether the printer A (31) is a color-unsupporting printer based on whether the attribute is false (step S4). The color-unsupporting printer refers to a monochrome printer.

If YES in step S4, the vendor auxiliary App 17 regards the printer A (31) as a business printer. Then, the vendor auxiliary App 17 selects, from the plurality of UI images stored in the storage unit 12, a business scan UI image as exemplified in a UI image 60 in FIG. 6, and displays the selected business scan UI image on the display unit 15 (step S6). The business scan UI image refers to an office scan UI image.

As illustrated, the UI image 60 includes, for example, a preview image 61, a button group 62 for shifting to various setting UI images, a PDF button 63 for saving the image data in PDF, and a scan button 64 for executing scanning. PDF is an abbreviation for portable document format. In business use, manuscripts are more likely to be documents than in home use. Therefore, as illustrated in the drawing, the preview image 61 may be, for example, a preview image of a plurality of pages by default, unlike the preview image 51.

Unlike the button group 52, the button group 62 is provided not to set the functions for home scanning but to set functions for business scan. The button group 62 can include, for example, a document image quality adjustment function button for shifting to a UI image for performing document image quality adjustment. The button group 62 can include, for example, an OCR function button for shifting to a UI image for performing a setting to perform OCR, and a bar code recognition function button for shifting to a UI image for performing a setting to recognize a bar code. OCR is an abbreviation for optical character recognition or optical character reader. However, the UI images 50 and 60 are not limited to the illustrated examples, and may differ in at least some of the settable functions, such as a difference between the button groups 52 and 62.

The selection processing is ended by the processing in step S6, and then the scan processing is executed by selecting the PDF button 63 or the scan button 64. When the setting to execute the OCR is made, the vendor auxiliary App 17 that receives the image data from the printer A (31) executes the OCR, and stores a result thereof in the storage unit 12. When the setting to recognize the bar code is made, the vendor auxiliary App 17 that receives the image data from the printer A (31) recognizes the bar code. Then, the vendor auxiliary App 17 can also store a result thereof in the storage unit 12 or can access a site indicated by the bar code via the communication unit 13. The OCR and the bar code recognition may be executed on a side of the printer A (31) and a result may be transmitted to the vendor auxiliary App 17.

If NO in step S4, the vendor auxiliary App 17 proceeds to the next determination. Specifically, the vendor auxiliary App 17 refers to a “pages-per-minute” attribute of the IPP and determines whether the printer A (31) is a high-speed print supporting printer, that is, a high-speed machine based on whether the attribute is more than a certain value (step S5). If YES in step S5, the processing proceeds to step S6. In step S6, the vendor auxiliary App 17 regards the printer A (31) as a business printer. Then, the vendor auxiliary App 17 selects, from the plurality of UI images stored in the storage unit 12, a business scan UI image as exemplified in the UI image 60 in FIG. 6, and displays the selected business scan UI image on the display unit 15. In this way, the vendor auxiliary App 17 regards a printer with fast printing speed as a business printer and displays the business scan UI image, that is, a document scan UI image. Accordingly, the selection processing is ended, and then the scan processing is executed by selecting the PDF button 63 or the scan button 64.

By the processing in FIG. 2 described above, a selection result illustrated in FIG. 3 is obtained. That is, when the scan button 43 is selected such that the printer A (31) is used in the scan processing, the home scan UI image is selected. Similarly, when any one of the scan buttons 46 and 49 is selected such that any one of the printer B (32) and the printer C (33) is used in the scan processing, the business scan UI image is selected. An order of the determinations in steps S2, S4, and S5 does not matter.

As illustrated in the UI image 40 in FIG. 4, the display processing described above may include the following processing. That is, the display processing may include processing of displaying, when the device information is acquired from a plurality of printers each having a scanning function in the acquisition processing, information indicating each of the plurality of printers described above and a selection button in association with each other. The selection button is a button for selecting a UI image corresponding to the device information of each of the plurality of printers described above, and is a call button for calling up such a corresponding UI image.

The information indicating each of the plurality of printers described above is exemplified by the appearance information 41, 44, and 47 and can include the product name of each of the printers as illustrated. The selection button is exemplified by the scan buttons 43, 46, and 49 for scanning, and are exemplified by the print buttons 42, 45, and 48 for printing.

By associating the printers with buttons for calling up the corresponding UIs, listing them, or enumerating them in this way, and presenting them to the user, the following effects can be achieved. That is, the user can easily select a printer to be used and select the image processing to be used from among printing or scanning. Then, the vendor auxiliary App 17 displays a UI image corresponding to a selection result thereof and allows the user to continue the operation based on the UI image.

As exemplified in steps S2, S3, and S6, in the display processing described above, one UI image can be selected from a plurality of UI images and displayed based on the type of paper supported by the printer indicated by the device information. Accordingly, a UI image suitable for the type of paper supported by the printer can be displayed.

In FIG. 2, an example is given in which the business scan UI image is selected if photo paper is not supported regardless of the determination result in step S4, and a different scan UI image may be selected according to the determination in step S4. That is, in the display processing described above, one UI image may be selected from a plurality of UI images and displayed based on a print color corresponding to the printer indicated by the device information, that is, a print color supported by the printer. Accordingly, a UI image suitable for the type of paper supported by the printer can be displayed.

In FIG. 2, an example is given in which the business scan UI image is selected if photo paper is not supported regardless of the determination result in step S5, and a different scan UI image may be selected according to the determination in step S5. That is, in the display processing described above, one UI image may be selected from the plurality of UI images and displayed based on a processing speed of the printer indicated by the device information. Accordingly, a UI image suitable for the processing speed such as a printing speed of the printer can be displayed. Here, the processing speed can include at least one of a printing speed and a scanning speed.

In addition, in the display processing, one UI image may be selected from a plurality of UI images and displayed based on a scan resolution corresponding to the printer indicated by the device information, that is, a maximum scan resolution that can be executed by the printer. Accordingly, a UI image suitable for a maximum value of the scan resolution of the printer can be displayed.

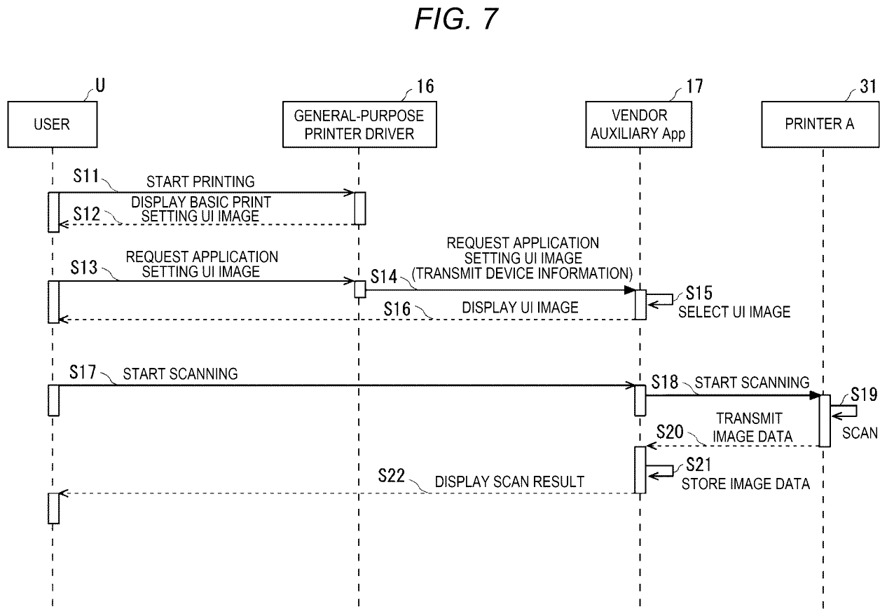

Next, an example of the scan processing in the print system 100 including the selection processing described above will be described with reference to FIG. 7. FIG. 7 is a sequence diagram illustrating an example of the scan processing in the print system 100. In the following, to simplify the description, the description will be given on an assumption that the scan processing is performed by the printer A (31).

First, the user U places a document on the document table or the automatic document feeder of the printer A (31), and performs an operation of activating the general-purpose printer driver 16 and an operation of selecting the printer A (31) by the operation unit 14. With these operations, the general-purpose printer driver 16 receives an instruction to start printing (step S11). At this time, when the device information required for the selection processing is not included in the printer queue of the printer A (31), the general-purpose printer driver 16 may acquire the device information from the printer A (31). This instruction is actually an instruction to print or scan. An order of the instruction and the placement may be reversed.

Based on the instruction received in step S11, the general-purpose printer driver 16 displays a basic print setting UI image (not illustrated) on the display unit 15 (step S12). The basic print setting UI image is a UI image for receiving a user operation for performing a basic setting of printing, and may include an application setting button for activating the vendor auxiliary App 17 to display an application setting UI image.

When the user U selects the application setting button by the operation unit 14, the user U requests the general-purpose printer driver 16 to display the application setting UI image (step S13).

Upon receiving the request, the general-purpose printer driver 16 transmits the device information of the printer A (31) acquired in advance to the vendor auxiliary App 17 while being instructed to activate the vendor auxiliary App 17 (step S14). The vendor auxiliary App 17 is activated according to an activation instruction to display the application setting UI image. The application setting UI image may be, for example, the UI image 40 in FIG. 4, or only the appearance information 41, the print button 42, and the scan button 43 of the printer A (31) in the UI image 40. Then, when receiving an operation of performing the scan processing from the user U in the application setting UI image, the vendor auxiliary App 17 selects a scan UI image based on the received device information (step S15). Accordingly, the following description will be made assuming that the UI image 50 in FIG. 5 is selected. For example, when the application setting button is a scan button, such display of the application setting UI image and the reception of the operation of performing the scan processing can be omitted.

Instead of steps S11 to S14, the following processing may be performed. That is, the user U directly performs an operation of activating the vendor auxiliary App 17 by the operation unit 14. The vendor auxiliary App 17 may be activated to acquire the device information of the printer A (31) via the general-purpose printer driver 16 when the target printer A (31) is selected and perform the processing in step S15.

Subsequent to step S15, the vendor auxiliary App 17 displays the selected UI image 50 on the display unit 15 (step S16). Next, the vendor auxiliary App 17 receives an instruction to start scanning when receiving a selection operation of the scan button 54 from the user U (step S17). The vendor auxiliary App 17 receives this instruction and instructs the printer A (31) to start scanning (step S19).

Upon receiving this instruction, the printer A (31) performs scanning to generate the image data (step S19). Next, the printer A (31) transmits the generated image data to the vendor auxiliary App 17 (step S20). The vendor auxiliary App 17 stores the received image data in the storage unit 12 (step S21), and displays a scan result on the display unit 15 (step S22). Accordingly, the user U can confirm the scan result. In this way, the scan processing ends.

### Example of Print Processing

An example of the print processing as an example of the image processing according to the embodiment will be briefly described. Even in the print processing, the selection of the UI image and the like can be basically performed in the same manner as in the scan processing.

In the case of the print processing, for example, the print processing is performed after a UI image enabling selection of a file to be printed is displayed or after the file to be printed is selected.

A UI image selected in the case of the print processing is different from that in the case of scan processing. For example, in the UI image 40 in FIG. 4, unlike the case of selecting the scan button 43, when the print button 42 is selected, a UI image suitable for the printer A (31) is displayed as a UI image for performing a setting of printing. Similarly, in the case of the print processing, for example, different UI images can be displayed depending on which of the print buttons 42, 45, and 48 is selected. For example, when the print button 42 is selected, a home print setting UI image may be displayed, and when any one of the print buttons 45 and 48 is selected, a business print setting UI: image may be displayed. Although the description of other details in the case of performing the print processing is omitted, it can be understood by appropriately referring to the description of the scan processing.

When performing printing from scanned image data after the scan processing, that is, when performing a copy, for example, the processing described as an example of the scan processing may be performed, and then the processing described as an example of the print processing may be performed. Accordingly, the scan UI image based on the device information of the printer and the print setting UI image based on the device information of the printer are appropriately displayed. Alternatively, a UI image may be prepared for copy processing. The UI image may include, for example, a copy button for performing copying in the UI image 40 in FIG. 4. For example, when a copy button for the printer A (31) is selected, the vendor auxiliary App 17 may display the following UI image. That is, for example, instead of the scan button 54 or in addition to the scan button 54 in the UI image 50 in FIG. 5, the vendor auxiliary App 17 may display a UI image including a copy button instead of or separately from the scan button 54 in the UI image 50 in FIG. 5 and also including a function button for performing the print setting. Then, the vendor auxiliary App 17 may perform copying when the copy button is selected.

### Effects of Present Embodiment

As described above, in the print system 100, the exemplary print control program in the vendor auxiliary App 17 can acquire the device information of the printer via the general-purpose printer driver 16, select the UI image based on the device information, and display the UI image. Therefore, according to the embodiment, an effect is achieved in which it is possible to provide the user with a setting suitable for the printer as a default setting in an environment in which the general-purpose printer driver 16 is used to cause the printer to execute image processing for printing or scanning. That is, according to the embodiment, the image processing suitable for the printer can be set with a simple configuration. From the user's perspective, it can be said that since a UI image suitable for the used printer can be displayed by simply installing the vendor auxiliary App 17, convenience can be improved. The selected UI image can also include individual default settings, and by having such a configuration, it can be said that the effects described above are enhanced in the embodiment.

To supplement such effects, the embodiment is compared with print systems according to Comparative Examples 1 and 2. The print systems according to Comparative Examples 1 and 2 are systems in which image processing is performed using a printer driver or a scanner driver specific to a vendor of a printer, instead of a general-purpose printer driver. In the print system according to Comparative Example 1, to change the UI image for each product of the printer, product information is defined in a printer driver or a scanner driver specific to the vendor, a type of the UI image is linked to the product name, and the UI image is selected according to the product. In the print system according to Comparative Example 2, to change the UI image for each product of the printer, a printer driver or a scanner driver specific to a vendor that differs for each type of product is used.

However, a vendor auxiliary application program such as a PSA is not distributed from a printer vendor site such as a printer driver or scanner driver specific to the vendor. The vendor auxiliary application program is distributed from an application store provided by the OS vendor. Therefore, when the print systems in Comparative Examples 1 and 2 are applied to an environment using a general-purpose printer driver, the following problems occur.

First, in Comparative Example 1, unlike a printer driver to be distributed for each model, it is not realistic for the OS vendor to distribute the printer driver for each model. In Comparative Example 1, when a large number of products are supported by one PSA, the vendor auxiliary application program needs to be updated when new products are launched. When new products are frequently launched, the PSA is updated automatically, whereas the driver specific to the vendor is manually updated by the user when needed. Therefore, in Comparative Example 1, useless updates are frequently performed for existing users, which impairs the user experience.

In Comparative Example 2, when a plurality of PSAs are registered by dividing them by product category, it becomes difficult for the user to search for a PSA when attempting to obtain the PSA by searching an application store provided by the OS vendor. This is because the user needs to search a plurality of PSAs for a PSA that corresponds to the product owned by the user. For example, when acquiring the vendor auxiliary application program from the application store, or when setting the Wi-Fi using the PSA, it may be necessary to install the PSA before generating a printer queue. In such a case, a PSA search is required, but in Comparative Example 2, the search is difficult for the user.

In contrast, in the embodiment, since there is no model table in the vendor auxiliary App 17, it is not necessary to update the vendor auxiliary App 17 in response to the new products, and the problem occurring in Comparative Example 1 does not occur. Further, in the embodiment, the vendor auxiliary App 17 can be unified regardless of the type of the scan UI image or the print setting UI image. Therefore, in the embodiment, since only one application can be found when searching the application store provided by the OS vendor for the vendor auxiliary App 17 by a manufacturer name, the problem occurring in Comparative Example 2 does not occur.

### Other Modifications

The present disclosure is not limited to the embodiment described above and can be changed as appropriate without departing from the gist of the present disclosure. For example, the system configuration of the print system, the configurations of the devices implementing the system, the configurations of the programs included in each device, the processing procedures of each device, and the like are not limited to the exemplified ones. The print system may also employ a network configuration in which a terminal device is connected to a printer via a print server. The vendor auxiliary App 17 may be configured to select the UI image based on the device information only in the scan processing, or may be configured to select the UI image based on the device information only in the print processing.

For example, how to select the scan UI image based on the device information is not limited to the example described above. For example, the scan UI image may be selected by another method such as a selection based on a naming rule of a model name of the printer. Further, the vendor auxiliary App 17 can also display an image automatically selected based on the device information as a scan UI image to be displayed first when activating, and then the user can manually switch to another scan UI image.

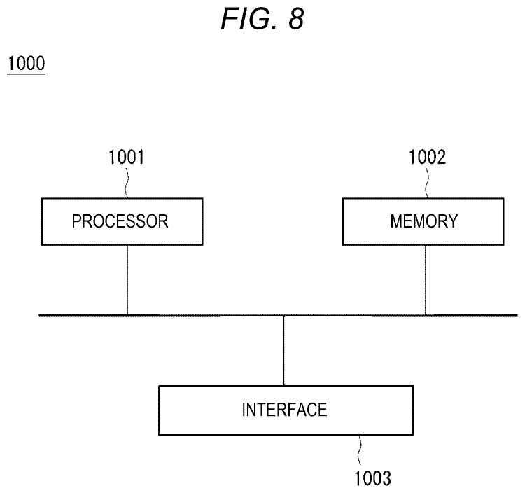

Each device included in the image processing system such as the print system according to the embodiment described above may have, for example, the following hardware configuration. Here, each device includes the terminal device and the printers in the example illustrated in FIG. 1. FIG. 8 is a diagram illustrating an example of a hardware configuration of a device.

A device 1000 illustrated in FIG. 8 can include a processor 1001, a memory 1002, and an interface 1003. The interface 1003 can include, for example, a communication interface or an interface with an input and output device, which are necessary depending on the device.

The processor 1001 may be, for example, a CPU, a GPU, or a microprocessor unit (MPU) also referred to as a microprocessor. The processor 1001 may include a plurality of processors. The memory 1002 is implemented by, for example, a combination of a volatile memory and a nonvolatile memory. Functions of each device are implemented by the processor 1001 reading a program stored in the memory 1002 and executing the program while exchanging necessary information via the interface 1003.

The program described above includes an instruction group (or software codes) for causing a computer to perform one or more functions described in the embodiment when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or another memory technology. Not as a limitation but as an example, the computer-readable medium or the tangible storage medium includes a CD-ROM, a digital versatile disc (DVD), a Blu-ray (registered trademark) disk, or another optical disc storage, a magnetic cassette, a magnetic tape, a magnetic disk storage, or another magnetic storage device. The program may be transmitted on a transitory computer-readable medium or a communication medium. Not as a limitation but as an example, the transitory computer-readable medium or the communication medium includes a propagation signal of an electric, optical, acoustic, or another form. The program is included in a program product.

The present disclosure is described with reference to the embodiment described above. The present disclosure is not limited only to the configuration in the embodiment described above, and it goes without saying that the present disclosure includes various variations, modifications, and combinations that can be achieved by those skilled in the art within the scope of the disclosure in the claims of the present application.

What is claimed is:

1. A non-transitory computer-readable storage medium storing a print control program, the print control program causing a computer to execute:
acquisition processing of acquiring device information of a printer having a scanning function from a general-purpose printer driver;
display processing of selecting one user interface image from a plurality of user interface images based on the device information and displaying the one user interface image; and
image processing of causing the printer to perform scanning or printing based on an instruction from a user via the one user interface image.

2. The non-transitory computer-readable storage medium storing the print control program according to claim 1, wherein
the print control program is a print support application.

3. The non-transitory computer-readable storage medium storing the print control program according to claim 1, wherein
in the acquisition processing, the device information is acquired using an IPP print device.

4. The non-transitory computer-readable storage medium storing the print control program according to claim 1, wherein
the display processing includes processing of displaying, when the device information is acquired for a plurality of printers each having a scanning function in the acquisition processing, information indicating each of the plurality of printers and a selection button for selecting a user interface image corresponding to the device information of each of the plurality of printers, in association with each other.

5. The non-transitory computer-readable storage medium storing the print control program according to claim 1, wherein
in the display processing, the one user interface image is selected from the plurality of user interface images based on a type of paper supported by the printer indicated by the device information and is displayed.

6. The non-transitory computer-readable storage medium storing the print control program according to claim 1, wherein
in the display processing, the one user interface image is selected from the plurality of user interface images based on a print color supported by the printer indicated by the device information and is displayed.

7. The non-transitory computer-readable storage medium storing the print control program according to claim 1, wherein
in the display processing, the one user interface image is selected from the plurality of user interface images based on a processing speed of the printer indicated by the device information and is displayed.

8. An image processing system comprising:
a general-purpose printer driver;
an acquisition processing unit configured to acquire device information of a printer from the general-purpose printer driver;
a display processing unit configured to select one user interface image from a plurality of user interface images based on the device information and display the one user interface image; and
an image processing unit configured to cause the printer to perform scanning or printing based on an instruction from a user via the one user interface image.

9. An image processing method comprising:
acquisition processing of a computer acquiring device information of a printer from a general-purpose printer driver;
display processing of the computer selecting one user interface image from a plurality of user interface images based on the device information and displaying the one user interface image; and
image processing of the computer causing the printer to perform scanning or printing based on an instruction from a user via the one user interface image.
